(19) United States
(12) Patent Application Publication
(10) Pub. No.: US 2018/0279357 A1
(43) Pub. Date: Sep. 27, 2018

(54) TECHNIQUES AND APPARATUSES FOR TEMPORARY MODIFICATION OF PERIODIC GRANTS

(71) Applicant: QUALCOMM Incorporated, San Diego, CA (US)

(72) Inventors: Leena ZACHARIAS, San Jose, CA (US); Srinivasan BALASUBRAMANIAN, San Diego, CA (US); Aziz GHOLMIEH, Del Mar, CA (US)

(21) Appl. No.: 15/680,911

(22) Filed: Aug. 18, 2017

Related U.S. Application Data
(60) Provisional application No. 62/474,251, filed on Mar. 21, 2017.

(51) Int. Cl. H04W 72/14; H04W 72/04; H04W 28/02; H04W 76/04; H04W 52/02

(52) U.S. Cl. CPC H04W 72/14; H04W 72/0446; H04W 72/042; H04W 88/02; H04W 76/048; H04W 52/0235; H04W 28/0278

(57) ABSTRACT

Certain aspects of the present disclosure generally relate to wireless communication. In some aspects, a wireless communication device such as a user equipment may receive an indicator associated with a periodic grant configuration, wherein the indicator identifies a release of a subsequent resource allocation of the one or more processors; and/or skip at least one communication period for traffic associated with the subsequent resource allocation of the one or more processors based at least in part on receiving the indicator. Numerous other aspects are provided.

### CROSS-REFERENCE TO RELATED APPLICATIONS UNDER 35 U.S.C. § 119

This application claims priority to Provisional Patent Application No. 62/474,251, filed Mar. 21, 2017, entitled “TECHNIQUES AND APPARATUSES FOR TEMPORARY MODIFICATION OF PERIODIC GRANTS,” which is hereby expressly incorporated by reference herein.

### FIELD OF THE DISCLOSURE

Aspects of the present disclosure generally relate to wireless communication, and more particularly to techniques and apparatuses for temporary modification of periodic grants.

### BACKGROUND

Wireless communication systems are widely deployed to provide various telecommunication services, such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, a national, a regional, and even a global level. An example of a telecommunication standard is Long Term Evolution (LTE). LTE is a set of enhancements to the Universal Mobile Telecommunications System (UMTS) mobile standard promulgated by Third Generation Partnership Project (3GPP). LTE is designed to better support mobile broadband Internet access by improving spectral efficiency, lowering costs, improving services, using new spectrum, and integrating with other open standards using OFDMA on the downlink (DL), SC-FDMA on the uplink (UL), and multiple-input multiple-output (MIMO) antenna technology.

### SUMMARY

In some aspects, a method of wireless communication may include receiving, by a user equipment (UE), an indicator associated with a periodic grant configuration, wherein the indicator identifies a release of a subsequent resource allocation of the UE; and/or skipping, by the UE, at least one communication period associated with the subsequent resource allocation of the UE based at least in part on receiving the indicator.

In some aspects, a wireless communication device may include a memory and one or more processors operatively coupled to the memory. The one or more processors may be configured to receive an indicator associated with a periodic grant configuration, wherein the indicator identifies a release of a subsequent resource allocation of the one or more processors; and/or skip at least one communication period associated with the subsequent resource allocation of the one or more processors based at least in part on receiving the indicator.

In some aspects, a non-transitory computer-readable medium may store one or more instructions for wireless communication. The one or more instructions, when executed by one or more processors of a wireless communication device, may cause the one or more processors to receive an indicator associated with a periodic grant configuration, wherein the indicator identifies a release of a subsequent resource allocation of the one or more processors; and/or skip at least one communication period associated with the subsequent resource allocation of the one or more processors based at least in part on receiving the indicator.

In some aspects, an apparatus for wireless communication may include means for receiving, by the apparatus, an indicator associated with a periodic grant configuration, wherein the indicator identifies a release of a subsequent resource allocation of the apparatus; and/or means for skipping, by the apparatus, at least one communication period associated with the subsequent resource allocation of the apparatus based at least in part on receiving the indicator.

In some aspects, a method of wireless communication may include receiving, by a UE, an indicator to initiate A sleep mode in a subsequent subframe, wherein the indicator is received in downlink control information for a frame including the next subframe; and/or initiating, by the UE, the sleep mode in the subsequent subframe based at least in part on the indicator.

In some aspects, a wireless communication device may include a memory and one or more processors operatively coupled to the memory. The one or more processors may be configured to receive an indicator to initiate a sleep mode in a subsequent subframe, wherein the indicator is received in downlink control information for a frame including the subsequent subframe; and/or initiate the sleep mode in the next subframe based at least in part on the indicator.

In some aspects, a non-transitory computer-readable medium may store one or more instructions for wireless communication. The one or more instructions, when executed by one or more processors of a wireless communication device, may cause the one or more processors to receive an indicator to initiate a sleep mode in a subsequent subframe, wherein the indicator is received in downlink control information for a frame including the subsequent subframe; and/or initiate the sleep mode in the next subframe based at least in part on the indicator.

In some aspects, an apparatus for wireless communication may include means for receiving, by the apparatus, an indicator to initiate a sleep mode in a subsequent subframe, wherein the indicator is received in downlink control information for a frame including the next subframe; and/or means for initiating, by the apparatus, the sleep mode in the subsequent subframe based at least in part on the indicator.

Aspects generally include a method, apparatus, system, computer program product, non-transitory computer-readable medium, user equipment, wireless communication device, and processing system as substantially described herein with reference to and as illustrated by the accompanying drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example deployment in which multiple wireless networks have overlapping coverage, in accordance with various aspects of the present disclosure.

FIG. 2 is a diagram illustrating an example access network in an LTE network architecture, in accordance with various aspects of the present disclosure.

FIG. 3 is a diagram illustrating an example of a downlink frame structure in LTE, in accordance with various aspects of the present disclosure.

FIG. 4 is a diagram illustrating an example of an uplink frame structure in LTE, in accordance with various aspects of the present disclosure.

FIG. 5 is a diagram illustrating an example of a radio protocol architecture for a user plane and a control plane in LTE, in accordance with various aspects of the present disclosure.

FIG. 6 is a diagram illustrating example components of an evolved Node B and a user equipment in an access network, in accordance with various aspects of the present disclosure.

FIGS. 7A-7E are diagrams of examples of temporarily modifying a semi-persistent scheduling grant based at least in part on downlink control information, in accordance with various aspects of the present disclosure.

FIG. 8 is a diagram of an example of entering a sleep mode (e.g., an immediate sleep mode) based at least in part on an indicator, in accordance with various aspects of the present disclosure.

FIG. 9 is a diagram illustrating an example process performed, for example, by user equipment (UE), in accordance with various aspects of the present disclosure.

FIG. 10 is a diagram illustrating an example process performed, for example, by a UE, in accordance with various aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for providing a thorough understanding of the various concepts. However, it will be apparent to those skilled in the art that these concepts may be practiced without these specific details.

The techniques described herein may be used for one or more of various wireless communication networks such as code division multiple access (CDMA) networks, time division multiple access (TDMA) networks, frequency division multiple access (FDMA) networks, orthogonal FDMA (OFDMA) networks, single carrier FDMA (SC-FDMA) networks, or other types of networks. A CDMA network may implement a radio access technology (RAT) such as universal terrestrial radio access (UTRA), CDMA2000, and/or the like. UTRA may include wideband CDMA (WCDMA) and/or other variants of CDMA. CDMA2000 may include Interim Standard (IS)-2000, IS-95 and IS-856 standards. IS-2000 may also be referred to as 1× radio transmission technology (1×RTT), CDMA2000 1×, and/or the like. A TDMA network may implement a RAT such as global system for mobile communications (GSM), enhanced data rates for GSM evolution (EDGE), or GSM/EDGE radio access network (GERAN). An OFDMA network may implement a RAT such as evolved UTRA (E-UTRA), ultra mobile broadband (UMB), Institute of Electrical and Electronics Engineers (IEEE) 802.11 (Wi-Fi), IEEE 802.16 (WiMAX), IEEE 802.20, Flash-OFDM, and/or the like. UTRA and E-UTRA may be part of the universal mobile telecommunication system (UMTS). 3GPP long-term evolution (LTE) and LTE-Advanced (LTE-A) are example releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the wireless networks and RATs mentioned above as well as other wireless networks and RATs.

Additionally, or alternatively, the techniques described herein may be used in connection with New Radio (NR), which may also be referred to as 5G. New Radio is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

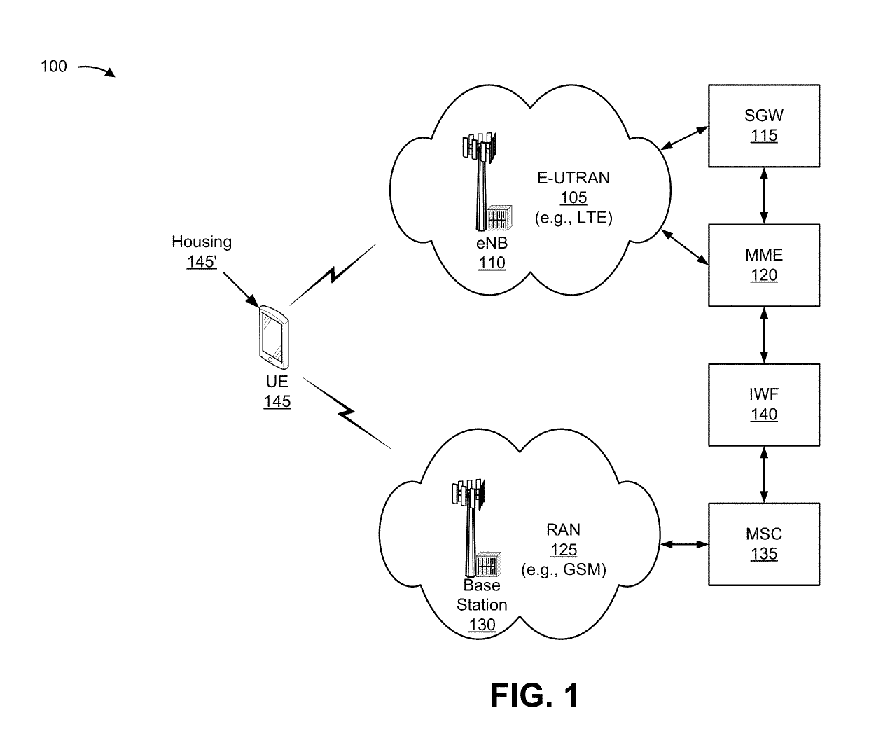

FIG. 1 is a diagram illustrating an example deployment 100 in which multiple wireless networks have overlapping coverage, in accordance with various aspects of the present disclosure. However, wireless networks may not have overlapping coverage in aspects. As shown, example deployment 100 may include an evolved universal terrestrial radio access network (E-UTRAN) 105, which may include one or more evolved Node Bs (eNBs) 110, and which may communicate with other devices or networks via a serving gateway (SGW) 115 and/or a mobility management entity (MME) 120. As further shown, example deployment 100 may include a radio access network (RAN) 125, which may include one or more base stations 130, and which may communicate with other devices or networks via a mobile switching center (MSC) 135 and/or an inter-working function (IWF) 140. As further shown, example deployment 100 may include one or more user equipment (UEs) 145 capable of communicating via E-UTRAN 105 and/or RAN 125.

E-UTRAN 105 may support, for example, LTE or another type of RAT. E-UTRAN 105 may include eNBs 110 and other network entities that can support wireless communication for UEs 145. Each eNB 110 may provide communication coverage for a particular geographic area. The term “cell” may refer to a coverage area of eNB 110 and/or an eNB subsystem serving the coverage area on a specific frequency channel. SGW 115 may communicate with E-UTRAN 105 and may perform various functions, such as packet routing and forwarding, mobility anchoring, packet buffering, initiation of network-triggered services, and/or the like. MME 120 may communicate with E-UTRAN 105 and SGW 115 and may perform various functions, such as mobility management, bearer management, distribution of paging messages, security control, authentication, gateway selection, and/or the like, for UEs 145 located within a geographic region served by MME 120 of E-UTRAN 105. The network entities in LTE are described in 3GPP TS 36.300, entitled “Evolved Universal Terrestrial Radio Access (E-UTRA) and Evolved Universal Terrestrial Radio Access Network (E-UTRAN); Overall description,” which is publicly available.

RAN 125 may support, for example, GSM or another type of RAT. RAN 125 may include base stations 130 and other network entities that can support wireless communication for UEs 145. MSC 135 may communicate with RAN 125 and may perform various functions, such as voice services, routing for circuit-switched calls, and mobility management for UEs 145 located within a geographic region served by MSC 135 of RAN 125. In some aspects, IWF 140 may facilitate communication between MME 120 and MSC 135 (e.g., when E-UTRAN 105 and RAN 125 use different RATs). Additionally, or alternatively, MME 120 may communicate directly with an MME that interfaces with RAN 125, for example, without IWF 140 (e.g., when E-UTRAN 105 and RAN 125 use a same RAT). In some aspects, E-UTRAN 105 and RAN 125 may use the same frequency and/or the same RAT to communicate with UE 145. In some aspects, E-UTRAN 105 and RAN 125 may use different frequencies and/or RATs to communicate with UEs 145. As used herein, the term base station is not tied to any particular RAT, and may refer to an eNB (e.g., of an LTE network) or another type of base station associated with a different type of RAT.

In general, any number of wireless networks may be deployed in a given geographic area. Each wireless network may support a particular RAT and may operate on one or more frequencies. A RAT may also be referred to as a radio technology, an air interface, and/or the like. A frequency or frequency ranges may also be referred to as a carrier, a frequency channel, and/or the like. Each frequency or frequency range may support a single RAT in a given geographic area in order to avoid interference between wireless networks of different RATs.

UE 145 may be stationary or mobile and may also be referred to as a mobile station, a terminal, an access terminal, a wireless communication device, a subscriber unit, a station, and/or the like. UE 145 may be a cellular phone, a personal digital assistant (PDA), a wireless modem, a wireless communication device, a handheld device, a laptop computer, a cordless phone, a wireless local loop (WLL) station, and/or the like. UE 145 may be included inside a housing 145′ that houses components of UE 145, such as processor components, memory components, and/or the like.

Upon power up, UE 145 may search for wireless networks from which UE 145 can receive communication services. If UE 145 detects more than one wireless network, then a wireless network with the highest priority may be selected to serve UE 145 and may be referred to as the serving network. UE 145 may perform registration with the serving network, if necessary. UE 145 may then operate in a connected mode to actively communicate with the serving network. Alternatively, UE 145 may operate in an idle mode and camp on the serving network if active communication is not required by UE 145.

UE 145 may operate in the idle mode as follows. UE 145 may identify all frequencies/RATs on which it is able to find a “suitable” cell in a normal scenario or an “acceptable” cell in an emergency scenario, where “suitable” and “acceptable” are specified in the LTE standards. UE 145 may then camp on the frequency/RAT with the highest priority among all identified frequencies/RATs. UE 145 may remain camped on this frequency/RAT until either (i) the frequency/RAT is no longer available at a predetermined threshold or (ii) another frequency/RAT with a higher priority reaches this threshold. In some aspects, UE 145 may receive a neighbor list when operating in the idle mode, such as a neighbor list included in a system information block type 5 (SIB 5) provided by an eNB of a RAT on which UE 145 is camped. Additionally, or alternatively, UE 145 may generate a neighbor list. A neighbor list may include information identifying one or more frequencies, at which one or more RATs may be accessed, priority information associated with the one or more RATs, and/or the like.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

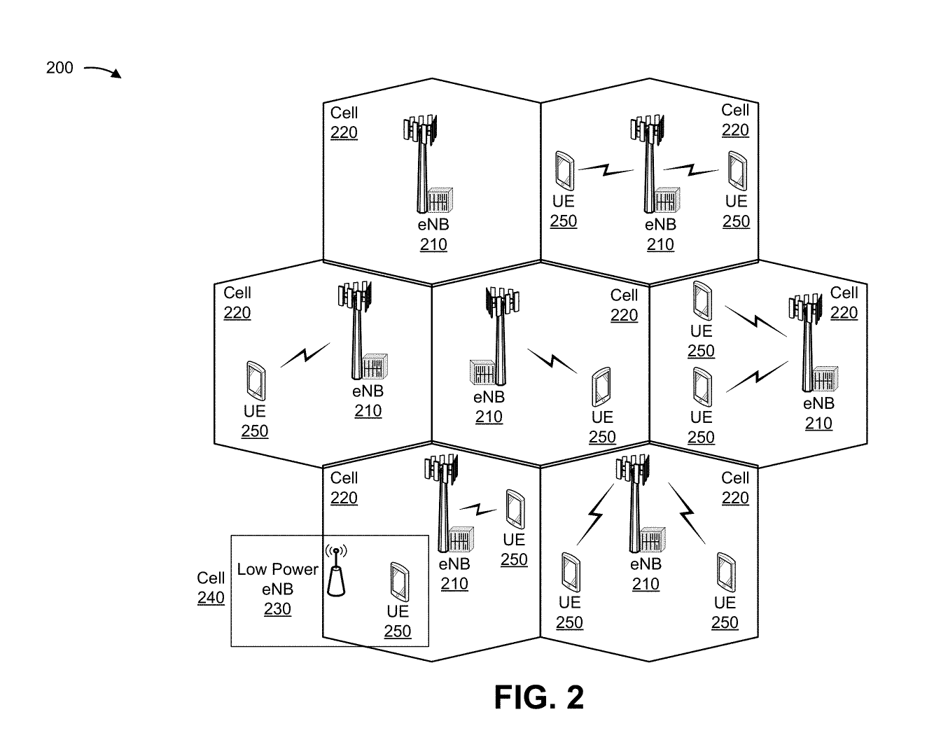

FIG. 2 is a diagram illustrating an example access network 200 in an LTE network architecture, in accordance with various aspects of the present disclosure. As shown, access network 200 may include one or more eNBs 210 (sometimes referred to as “base stations” herein) that serve a corresponding set of cellular regions (cells) 220, one or more low power eNBs 230 that serve a corresponding set of cells 240, and a set of UEs 250.

Each eNB 210 may be assigned to a respective cell 220 and may be configured to provide an access point to a RAN. For example, eNB 110, 210 may provide an access point for UE 145, 250 to E-UTRAN 105 (e.g., eNB 210 may correspond to eNB 110, shown in FIG. 1) or may provide an access point for UE 145, 250 to RAN 125 (e.g., eNB 210 may correspond to base station 130, shown in FIG. 1). In some cases, the terms base station and eNB may be used interchangeably, and a base station, as used herein, is not tied to any particular RAT. UE 145, 250 may correspond to UE 145, shown in FIG. 1. FIG. 2 does not illustrate a centralized controller for example access network 200, but access network 200 may use a centralized controller in some aspects. The eNBs 210 may perform radio related functions including radio bearer control, admission control, mobility control, scheduling, security, and network connectivity (e.g., to SGW 115).

As shown in FIG. 2, one or more low power eNBs 230 may serve respective cells 240, which may overlap with one or more cells 220 served by eNBs 210. The eNBs 230 may correspond to eNB 110 associated with E-UTRAN 105 and/or base station 130 associated with RAN 125, shown in FIG. 1. A low power eNB 230 may be referred to as a remote radio head (RRH). The low power eNB 230 may include a femto cell eNB (e.g., home eNB (HeNB)), a pico cell eNB, a micro cell eNB, and/or the like.

A modulation and multiple access scheme employed by access network 200 may vary depending on the particular telecommunications standard being deployed. In LTE applications, OFDM is used on the downlink (DL) and SC-FDMA is used on the uplink (UL) to support both frequency division duplexing (FDD) and time division duplexing (TDD). The various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. As another example, these concepts may also be extended to UTRA employing WCDMA and other variants of CDMA (e.g., such as TD-SCDMA, GSM employing TDMA, E-UTRA, and/or the like), UMB, IEEE 802.11 (Wi-Fi), IEEE 802.16 (WiMAX), IEEE 802.20, Flash-OFDM employing OFDMA, and/or the like. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 210 may have multiple antennas supporting MIMO technology. The use of MIMO technology enables eNBs 210 to exploit the spatial domain to support spatial multiplexing, beamforming, and transmit diversity. Spatial multiplexing may be used to transmit different streams of data simultaneously on the same frequency. The data streams may be transmitted to a single UE 145, 250 to increase the data rate or to multiple UEs 250 to increase the overall system capacity. This may be achieved by spatially precoding each data stream (e.g., applying a scaling of an amplitude and a phase) and then transmitting each spatially precoded stream through multiple transmit antennas on the DL. The spatially precoded data streams arrive at the UE(s) 250 with different spatial signatures, which enables each of the UE(s) 250 to recover the one or more data streams destined for that UE 145, 250. On the UL, each UE 145, 250 transmits a spatially precoded data stream, which enables eNBs 210 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

The number and arrangement of devices and cells shown in FIG. 2 are provided as an example. In practice, there may be additional devices and/or cells, fewer devices and/or cells, different devices and/or cells, or differently arranged devices and/or cells than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

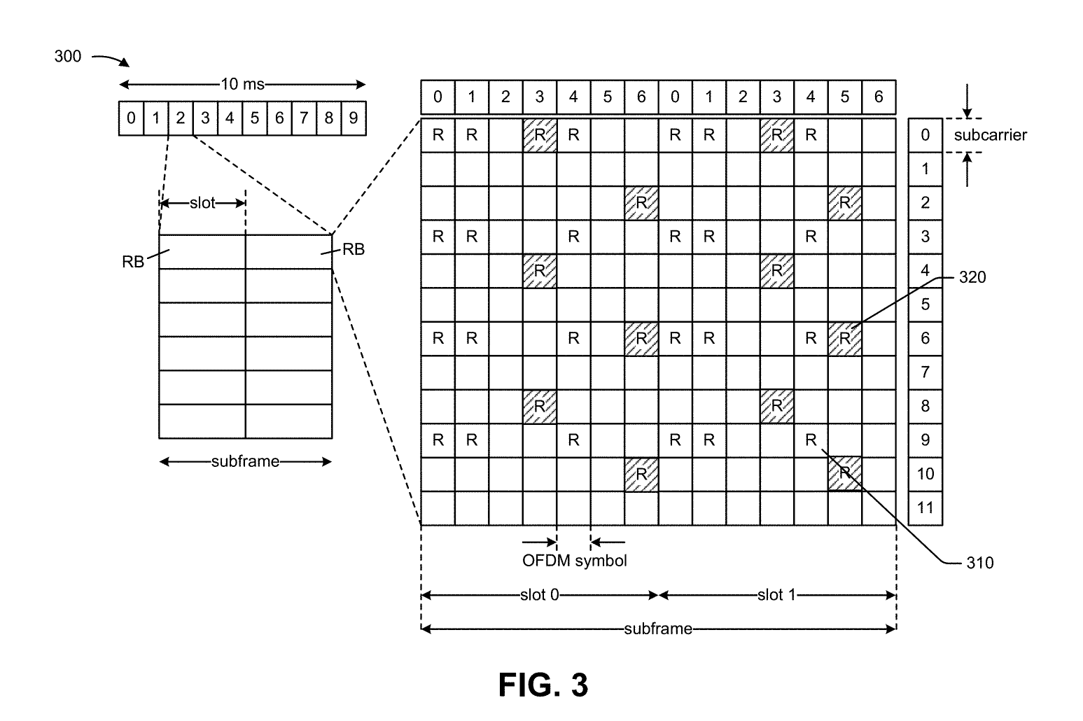

FIG. 3 is a diagram illustrating an example 300 of a downlink (DL) frame structure in LTE, in accordance with various aspects of the present disclosure. A frame (e.g., of 10 ms) may be divided into 10 equally sized sub-frames with indices of 0 through 9. Each sub-frame may include two consecutive time slots. A resource grid may be used to represent two time slots, each time slot including a resource block (RB). The resource grid is divided into multiple resource elements. In LTE, a resource block includes 12 consecutive subcarriers in the frequency domain and, for a normal cyclic prefix in each OFDM symbol, 7 consecutive OFDM symbols in the time domain, or 84 resource elements. For an extended cyclic prefix, a resource block includes 6 consecutive OFDM symbols in the time domain and has 72 resource elements. Some of the resource elements, as indicated as R 310 and R 320, include DL reference signals (DL-RS). The DL-RS include Cell-specific RS (CRS) (also sometimes called common RS) 310 and UE-specific RS (UE-RS) 320. UE-RS 320 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix (CP). The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in the first symbol period of each subframe. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. The eNB may send a Physical HARQ Indicator Channel (PHICH) and a Physical Downlink Control Channel (PDCCH) in the first M symbol periods of each subframe. The PHICH may carry information to support hybrid automatic repeat request (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink. In some aspects, downlink and/or uplink traffic may be scheduled using a periodic scheduling grant, such as a grant associated with semi-persistent scheduling (SPS) and/or the like.

The eNB may send the PSS, SSS, and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH, and PHICH in a broadcast manner to all UEs, may send the PDCCH in a unicast manner to specific UEs, and may also send the PDSCH in a unicast manner to specific UEs.

A number of resource elements may be available in each symbol period. Each resource element (RE) may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1, and 2. The PDCCH may occupy 9, 18, 36, or 72 REGs, which may be selected from the available REGs, in the first M symbol periods, for example. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

As indicated above, FIG. 3 is provided as an example. Other examples are possible and may differ from what was described above in connection with FIG. 3.

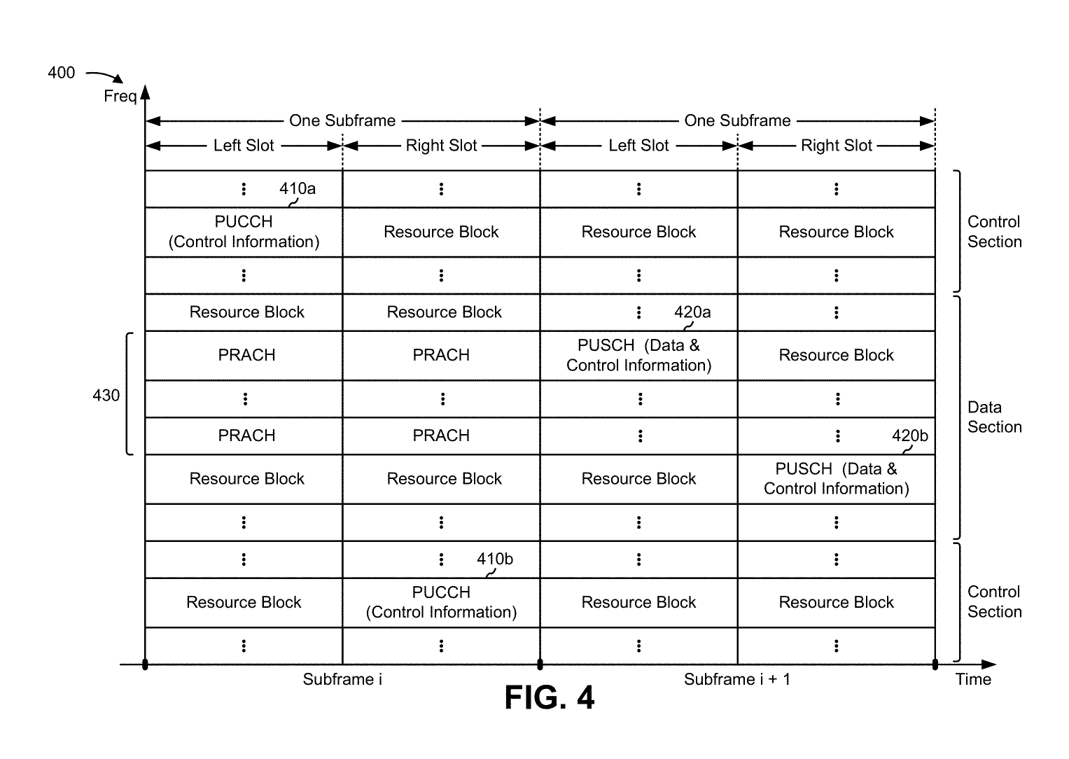

FIG. 4 is a diagram illustrating an example 400 of an uplink (UL) frame structure in LTE, in accordance with various aspects of the present disclosure. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequencies.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (e.g., of 1 ms) or in a sequence of few contiguous subframes and a UE can make only a single PRACH attempt per frame (e.g., of 10 ms).

As indicated above, FIG. 4 is provided as an example. Other examples are possible and may differ from what was described above in connection with FIG. 4.

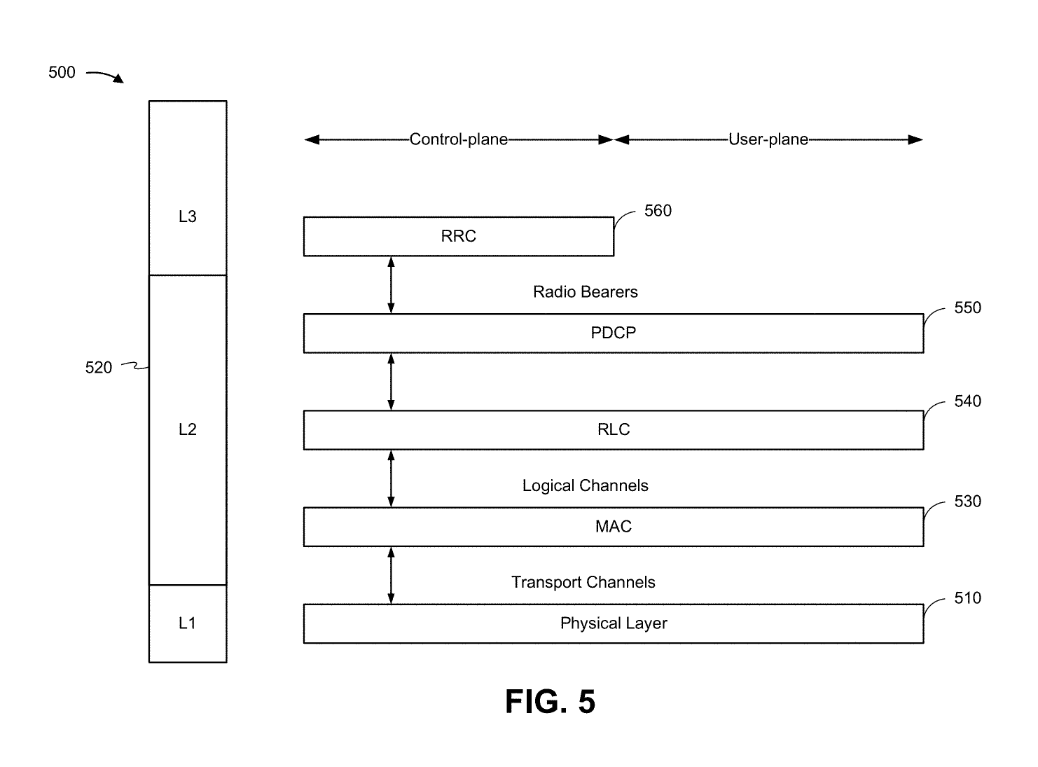

FIG. 5 is a diagram illustrating an example 500 of a radio protocol architecture for a user plane and a control plane in LTE, in accordance with various aspects of the present disclosure. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 510. Layer 2 (L2 layer) 520 is above the physical layer 510 and is responsible for the link between the UE and eNB over the physical layer 510.

In the user plane, the L2 layer 520 includes, for example, a media access control (MAC) sublayer 530, a radio link control (RLC) sublayer 540, and a packet data convergence protocol (PDCP) sublayer 550, which are terminated at the eNB on the network side. Although not shown, the UE may have several upper layers above the L2 layer 520 including a network layer (e.g., IP layer) that is terminated at a packet data network (PDN) gateway on the network side, and an application layer that is terminated at the other end of the connection (e.g., a far end UE, a server, and/or the like).

The PDCP sublayer 550 provides retransmission of lost data in handover. The PDCP sublayer 550 also provides header compression for upper layer data packets to reduce radio transmission overhead, security by ciphering the data packets, and handover support for UEs between eNBs. The RLC sublayer 540 provides segmentation and reassembly of upper layer data packets, retransmission of lost data packets, and reordering of data packets to compensate for out-of-order reception due to hybrid automatic repeat request (HARQ). The MAC sublayer 530 provides multiplexing between logical and transport channels. The MAC sublayer 530 is also responsible for allocating the various radio resources (e.g., resource blocks) in one cell among the UEs. The MAC sublayer 530 is also responsible for HARQ operations.

In the control plane, the radio protocol architecture for the UE and eNB is substantially the same for the physical layer 510 and the L2 layer 520 with the exception that there is no header compression function for the control plane. The control plane also includes a radio resource control (RRC) sublayer 560 in Layer 3 (L3 layer). The RRC sublayer 560 is responsible for obtaining radio resources (i.e., radio bearers) and for configuring the lower layers using RRC signaling between the eNB and the UE.

As indicated above, FIG. 5 is provided as an example. Other examples are possible and may differ from what was described above in connection with FIG. 5.

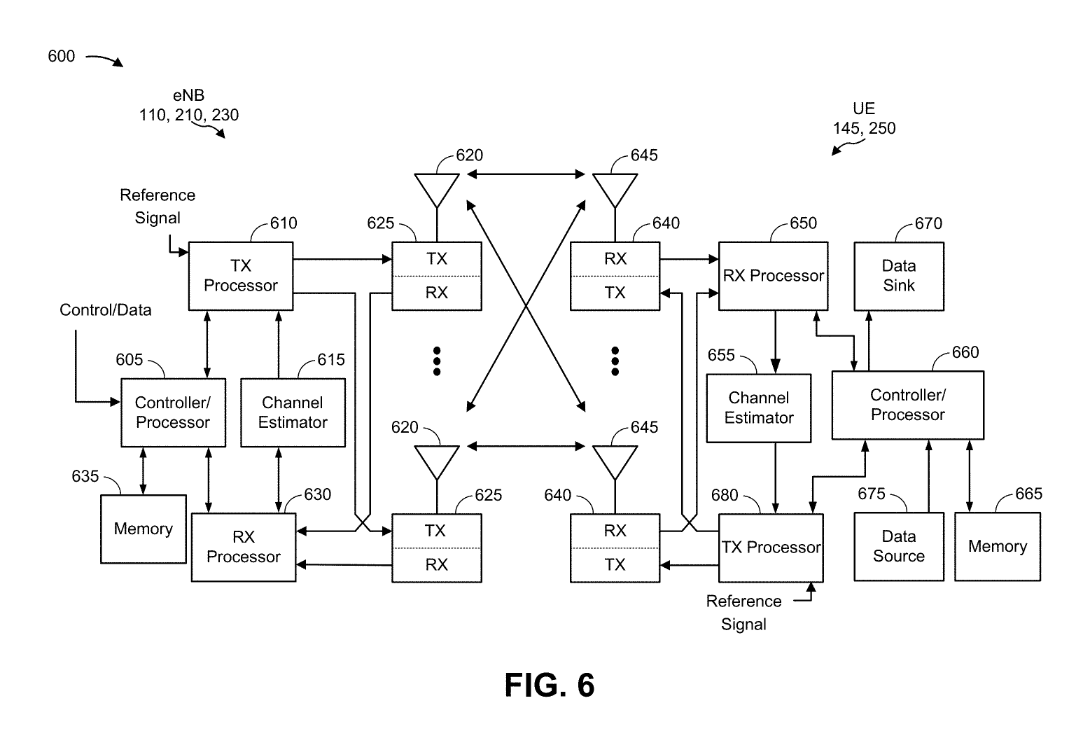

FIG. 6 is a diagram illustrating example components 600 of eNB 110, 210, 230 and UE 145, 250 in an access network, in accordance with various aspects of the present disclosure. As shown in FIG. 6, eNB 110, 210, 230 may include a controller/processor 605, a TX processor 610, a channel estimator 615, an antenna 620, a transmitter 625TX, a receiver 625RX, an RX processor 630, and a memory 635. As further shown in FIG. 6, UE 145, 250 may include a receiver RX, for example, of a transceiver TX/RX 640, a transmitter TX, for example, of a transceiver TX/RX 640, an antenna 645, an RX processor 650, a channel estimator 655, a controller/processor 660, a memory 665, a data sink 670, a data source 675, and a TX processor 680.

In the DL, upper layer packets from the core network are provided to controller/processor 605. The controller/processor 605 implements the functionality of the L2 layer. In the DL, the controller/processor 605 provides header compression, ciphering, packet segmentation and reordering, multiplexing between logical and transport channels, and radio resource allocations to the UE 145, 250 based, at least in part, on various priority metrics. The controller/processor 605 is also responsible for HARQ operations, retransmission of lost packets, and signaling to the UE 145, 250.

The TX processor 610 implements various signal processing functions for the L1 layer (e.g., physical layer). The signal processing functions includes coding and interleaving to facilitate forward error correction (FEC) at the UE 145, 250 and mapping to signal constellations based, at least in part, on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 615 may be used to determine the coding and modulation scheme, as well as for spatial processing. The channel estimate may be derived from a reference signal and/or channel condition feedback transmitted by the UE 145, 250. Each spatial stream is then provided to a different antenna 620 via a separate transmitter TX, for example, of transceiver TX/RX 625. Each such transmitter TX modulates an RF carrier with a respective spatial stream for transmission.

At the UE 145, 250, each receiver RX, for example, of a transceiver TX/RX 640 receives a signal through its respective antenna 645. Each such receiver RX recovers information modulated onto an RF carrier and provides the information to the receiver (RX) processor 650. The RX processor 650 implements various signal processing functions of the L1 layer. The RX processor 650 performs spatial processing on the information to recover any spatial streams destined for the UE 145, 250. If multiple spatial streams are destined for the UE 145, 250, the spatial streams may be combined by the RX processor 650 into a single OFDM symbol stream. The RX processor 650 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 110, 210, 230. These soft decisions may be based, at least in part, on channel estimates computed by the channel estimator 655. The soft decisions are then decoded and deinterleaved to recover the data and control signals that were originally transmitted by the eNB 110, 210, 230 on the physical channel. The data and control signals are then provided to the controller/processor 660.

The controller/processor 660 implements the L2 layer. The controller/processor 660 can be associated with a memory 665 that stores program codes and data. The memory 665 may include a non-transitory computer-readable medium. In the UL, the controller/processor 660 provides demultiplexing between transport and logical channels, packet reassembly, deciphering, header decompression, control signal processing to recover upper layer packets from the core network. The upper layer packets are then provided to a data sink 670, which represents all the protocol layers above the L2 layer. Various control signals may also be provided to the data sink 670 for L3 processing. The controller/processor 660 is also responsible for error detection using an acknowledgement (ACK) and/or negative acknowledgement (NACK) protocol to support HARQ operations.

In the UL, a data source 675 is used to provide upper layer packets to the controller/processor 660. The data source 675 represents all protocol layers above the L2 layer. Similar to the functionality described in connection with the DL transmission by the eNB 110, 210, 230, the controller/processor 660 implements the L2 layer for the user plane and the control plane by providing header compression, ciphering, packet segmentation and reordering, and multiplexing between logical and transport channels based, at least in part, on radio resource allocations by the eNB 110, 210, 230. The controller/processor 660 is also responsible for HARQ operations, retransmission of lost packets, and signaling to the eNB 110, 210, 230.

Channel estimates derived by a channel estimator 655 from a reference signal or feedback transmitted by the eNB 110, 210, 230 may be used by the TX processor 680 to select the appropriate coding and modulation schemes, and to facilitate spatial processing. The spatial streams generated by the TX processor 680 are provided to different antenna 645 via separate transmitters TX, for example, of transceivers TX/RX 640. Each transmitter TX, for example, of transceiver TX/RX 640 modulates an RF carrier with a respective spatial stream for transmission.

The UL transmission is processed at the eNB 110, 210, 230 in a manner similar to that described in connection with the receiver function at the UE 145, 250. Each receiver RX, for example, of transceiver TX/RX 625 receives a signal through its respective antenna 620. Each receiver RX, for example, of transceiver TX/RX 625 recovers information modulated onto an RF carrier and provides the information to a RX processor 630. The RX processor 630 may implement the L1 layer.

The controller/processor 605 implements the L2 layer. The controller/processor 605 can be associated with a memory 635 that stores program code and data. The memory 635 may be referred to as a computer-readable medium. In the UL, the control/processor 605 provides demultiplexing between transport and logical channels, packet reassembly, deciphering, header decompression, control signal processing to recover upper layer packets from the UE 145, 250. Upper layer packets from the controller/processor 605 may be provided to the core network. The controller/processor 605 is also responsible for error detection using an ACK and/or NACK protocol to support HARQ operations.

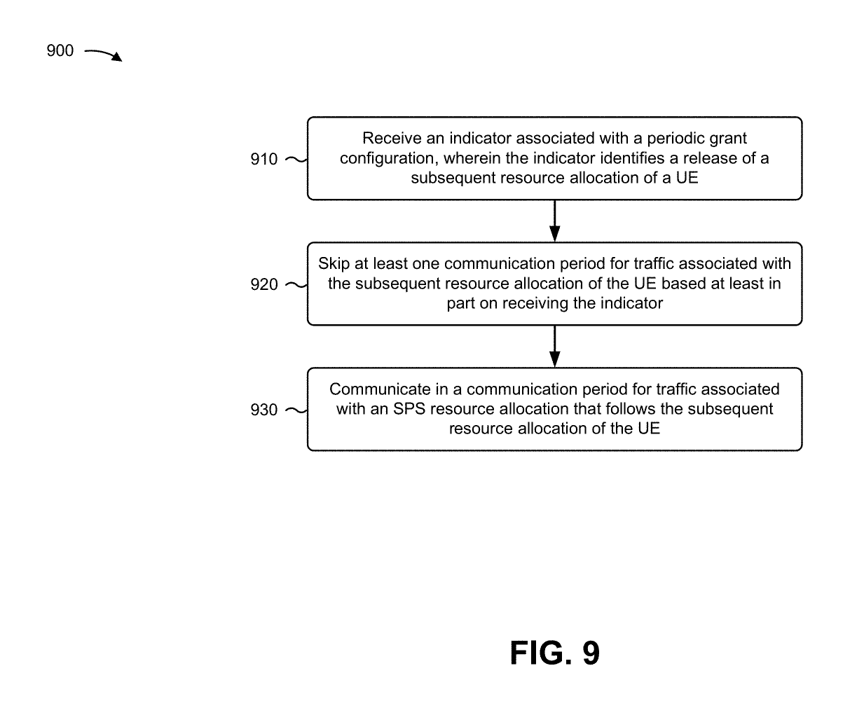

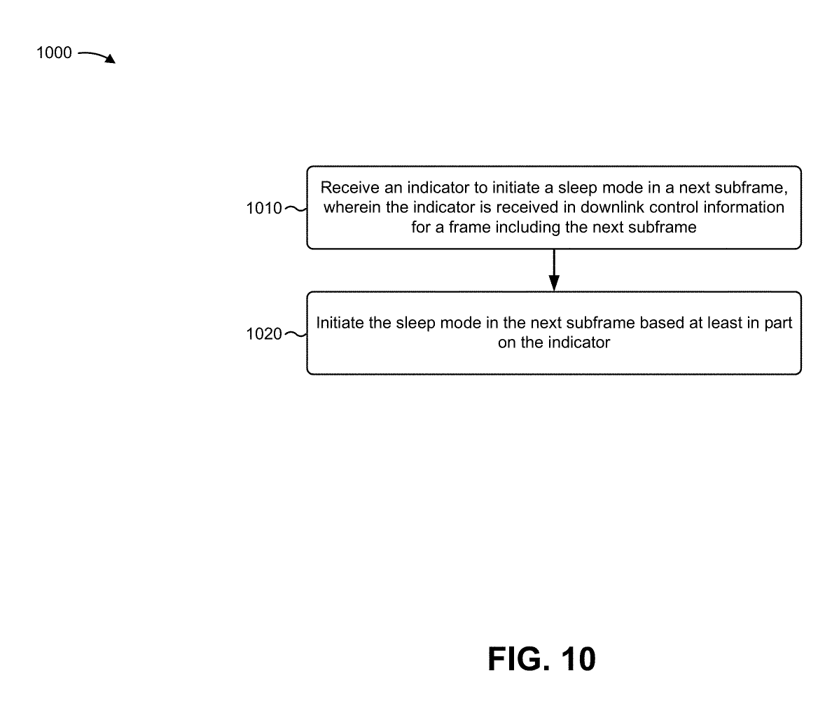

In some aspects, one or more components of UE 145, 250 may be included in a housing 145′, as shown in FIG. 1. One or more components of UE 145, 250 may be configured to perform temporary modification of periodic grants, as described in more detail elsewhere herein. For example, the controller/processor 660 and/or other processors and modules of UE 145, 250 may perform or direct operations of, for example, process 900 of FIG. 9, process 1000 of FIG. 10, and/or other processes as described herein. In some aspects, one or more of the components shown in FIG. 6 may be employed to perform example process 900, example process 1000, and/or other processes for the techniques described herein.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of components (e.g., one or more components) shown in FIG. 6 may perform one or more functions described as being performed by another set of components shown in FIG. 6.

An eNB 110, 210, 230 may allocate network resources (e.g., downlink resources and/or uplink resources) to facilitate communication with a UE 145, 250. For example, the UE 145, 250 may communicate in communication periods corresponding to the network resources (e.g., in particular subframes and/or resource blocks assigned by the eNB 110, 210, 230 for the UE 145, 250). In some aspects, downlink and/or uplink communications of the UE 145, 250 may be predictable. As one example, a UE 145, 250 on a Voice over LTE (VoLTE) call may transmit communications (e.g., packets) at a 40 ms interval when in a talk mode, may receive communications at a 40 ms interval when in a listen mode, and may transmit or receive communications at a 160 ms interval when in a silent mode.

The eNB 110, 210, 230 may provide a periodic grant of resources for a UE 145, 250 that may communicate (e.g., transmit or receive) periodic traffic, such as VoLTE traffic and/or the like. A periodic grant is a grant of network resources that occurs at a predefined interval in time, subframes, or slots. For example, the eNB 110, 210, 230 may use semi-persistent scheduling (SPS), or a similar approach, to provide the periodic grant. SPS may reserve resources for the UE 145, 250 at periodically configured subframes. The UE 145, 250 may communicate in the periodically configured subframes without receiving scheduling information (e.g., downlink control information) corresponding to each periodically configured subframe. Thus, the UE 145, 250 conserves processor resources and/or reduces latency relative to communicating in the periodically configured subframes based at least in part on scheduling information (e.g., downlink control information) corresponding to each periodically configured subframe.

However, SPS may be difficult to use in a loaded cellular network, since SPS may reduce flexibility of the eNB 110, 210, 230 to accommodate changing traffic conditions. Furthermore, the periodic communications of the UE 145, 250 may change in periodicity. For example, the UE 145, 250 may change from a 40 ms interval (e.g., in a VoLTE talk or listen mode) to a 160 ms interval (e.g., in a VoLTE silent mode). In such a case, the eNB 110, 210, 230 may let an existing SPS grant go unused, or may tear down the SPS grant and generate a new SPS grant for the changed interval. Both of these approaches may be inefficient and/or wasteful of resources of the UE 145, 250 and the eNB 110, 210, 230.

Techniques and apparatuses described herein permit a UE 145, 250 to temporarily modify a periodic grant based at least in part on receiving an indicator identifying a release of a subsequent SPS resource allocation. For example, the UE 145, 250 may skip at least one communication period (e.g., for traffic) associated with the subsequent SPS resource allocation based at least in part on receiving the indicator. The indicator may be included in downlink control information (DCI) received by the UE 145, 250, and need not be included in a subframe designated for scheduling information associated with the subsequent SPS resource allocation (e.g., a subframe designated for DCI regarding a subframe that includes the subsequent SPS resource allocation). Thus, flexibility of scheduling of network resources is improved with regard to SPS, relative to abandoning or tearing down an SPS grant due to a subsequent change in a traffic pattern. In some aspects, the indicator may indicate to release multiple SPS resource allocations, may indicate that the UE 145, 250 is to enter a sleep mode, may identify a different communication period in which the UE 145, 250 is to communicate, and/or the like, as described in more detail below. Thus, flexibility of scheduling of network resources is further improved, and processor, baseband, and/or battery resources of the UE 145, 250 may be conserved relative to abandoning the subsequent SPS allocation.

While techniques and apparatuses, described herein, are described primarily in the context of SPS, techniques and apparatuses are not limited to SPS. For example, aspects described herein may be applied for any type of resource grant occurring at a predefined interval.

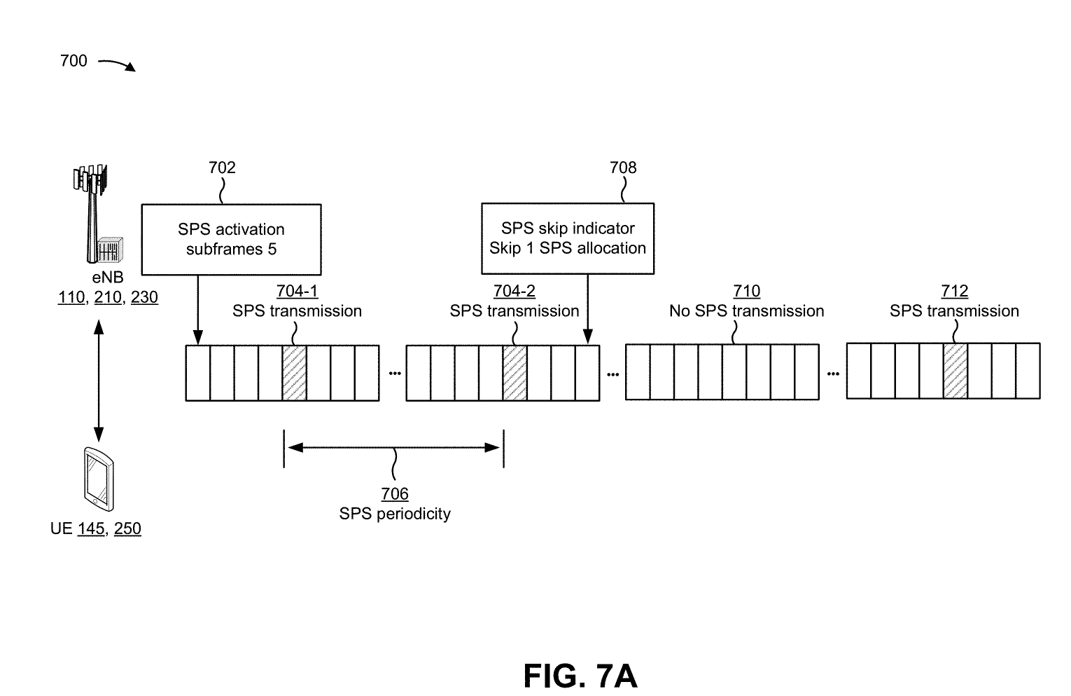

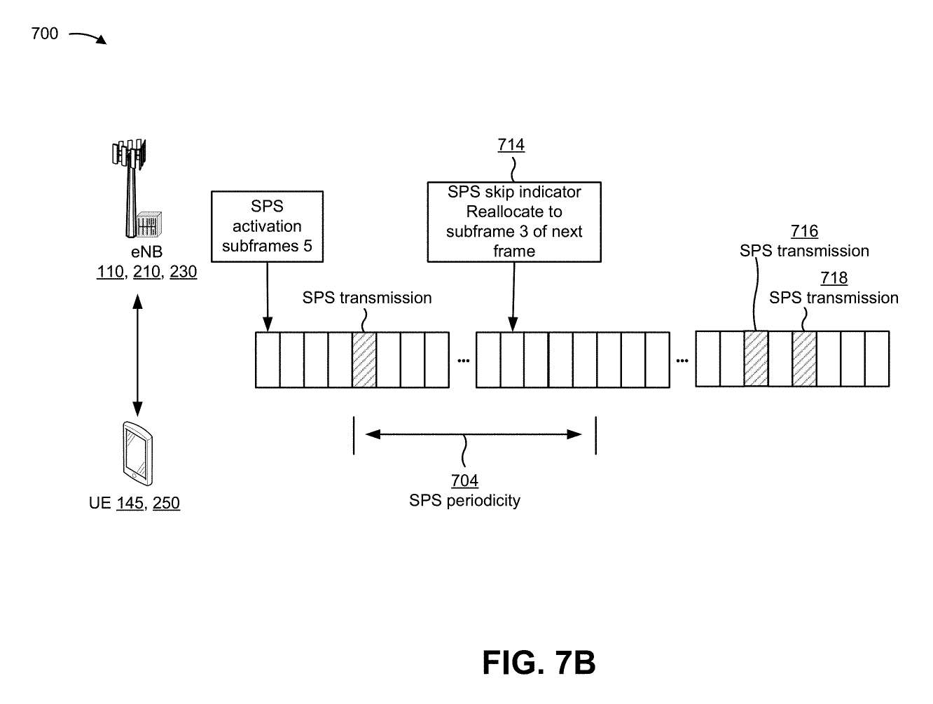

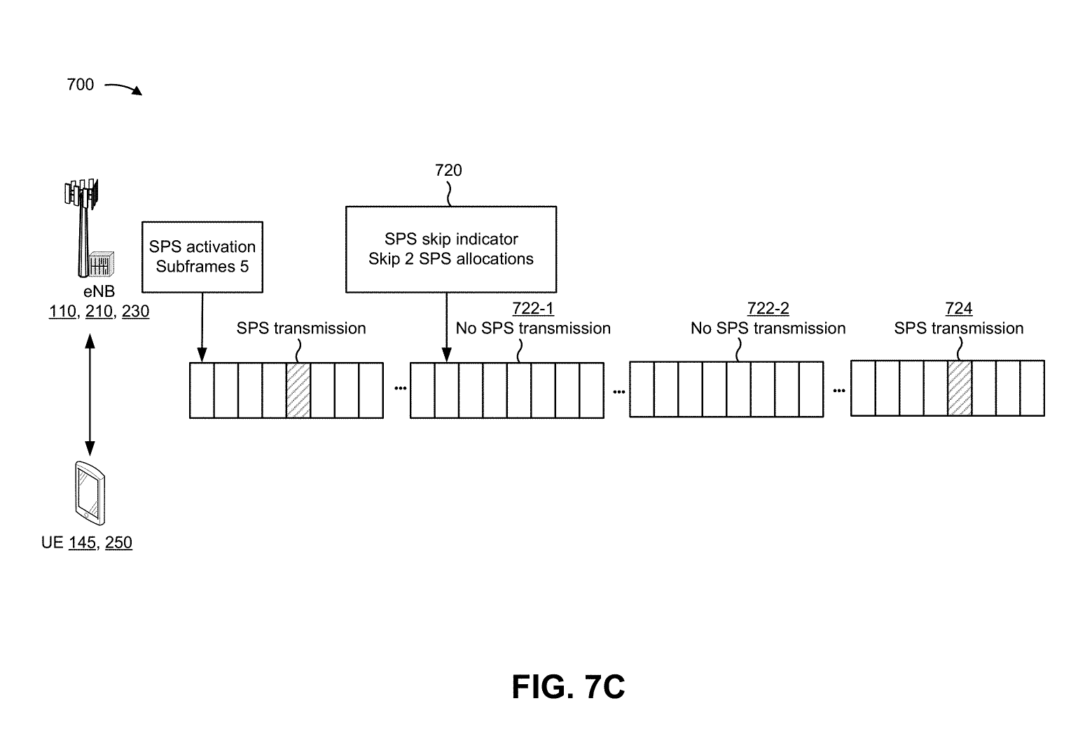

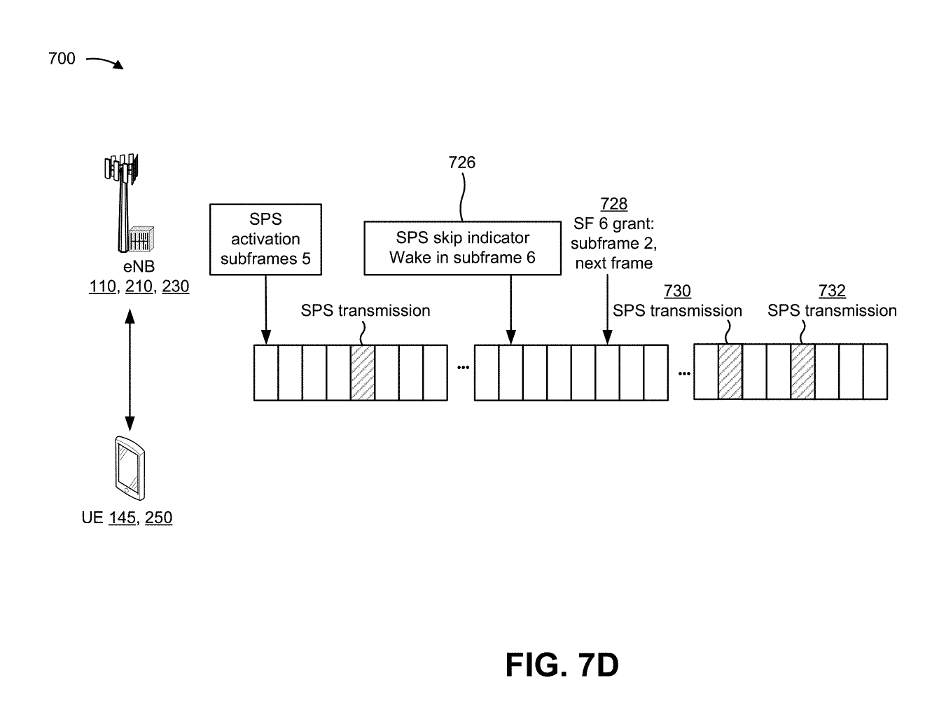

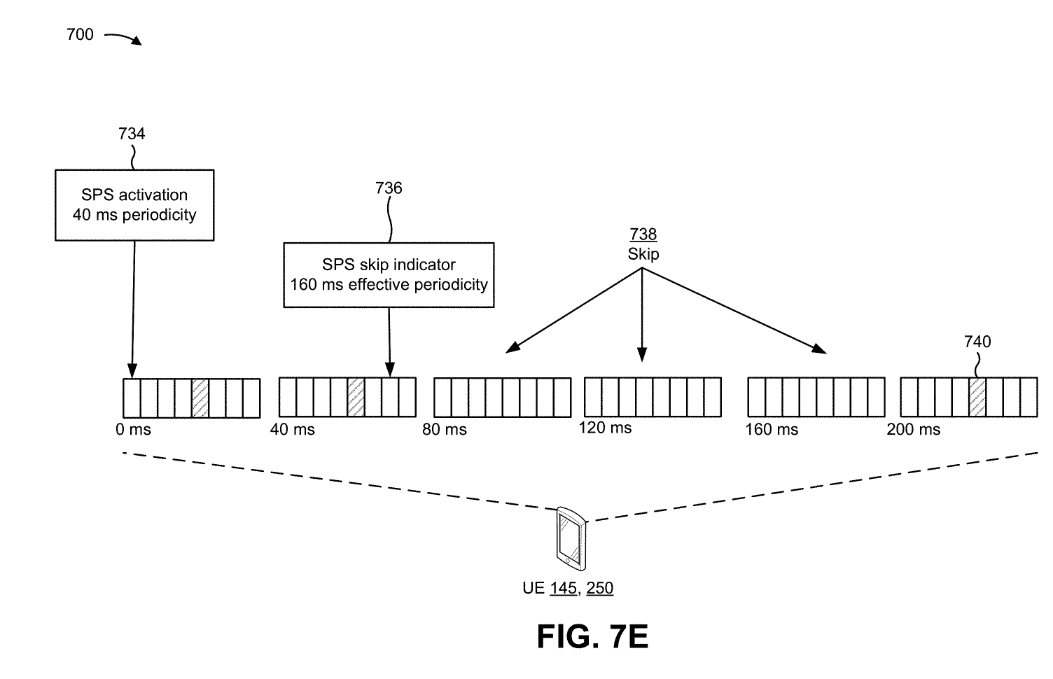

FIGS. 7A-7E are diagrams of examples 700 of temporarily modifying a semi-persistent scheduling grant based at least in part on downlink control information, in accordance with various aspects of the present disclosure.

FIG. 7A is an example of skipping a single SPS resource allocation based at least in part on a received indicator. As shown in FIG. 7A, an eNB 110, 210, 230 may communicate with a UE 145, 250 to schedule a periodic grant of resources in which the UE 145, 250 is to communicate. For example, as shown by reference number 702, the eNB 110, 210, 230 may transmit SPS activation information to the UE 145, 250. The SPS activation information may identify a periodic grant, and the UE 145, 250 may transmit or receive communications in communication periods corresponding to the periodic grant. Here, the periodic grant is shown as occurring in a fifth subframe of each set of subframes. For example, each set of subframes may correspond to a frame, and the UE 145, 250 may transmit or receive information associated with the periodic grant in each fifth subframe. While FIGS. 7A-7E are described in the context of transmissions during SPS resource allocations and/or reconfigured resource allocations, FIGS. 7A-7E are equally applicable to receptions during such resource allocations. In other words, SPS resource allocations may be usable in the uplink direction and/or in the downlink direction.

As shown by reference numbers 704-1 and 704-2, the UE 145, 250 may transmit a communication on each fifth subframe of the frames. In some aspects, the UE 145, 250 may receive a communication on each fifth subframe, or may transmit and receive communications on each fifth subframe. As shown by reference number 706, the SPS transmissions may have a particular periodicity. For example, the particular periodicity may be 40 ms for a VoLTE talk mode or VoLTE listen mode call, 160 ms for a VoLTE silent mode call, and/or the like. In some aspects, the particular periodicity may be equal to a quantity of subframes in each set of subframes.

As shown by reference number 708, the UE 145, 250 may receive a skip indicator from the eNB 110, 210, 230. The skip indicator may indicate to skip a subsequent SPS resource allocation. For example, the skip indicator shown by reference number 708 indicates to skip a communication period associated with a single, subsequent (e.g., a next) SPS resource allocation. In some aspects, the skip indicator may indicate to skip multiple, different communication periods, as described in more detail elsewhere herein.

In some aspects, the skip indicator may be received in any subframe of a particular frame, and the UE 145, 250 may skip a subsequent SPS resource allocation, irrespective of when the skip indicator is received (e.g., irrespective of a subframe in which the skip indicator is received). For example, the skip indicator need not be received in a subframe designated for control information of the subframe including the SPS resource allocation, or in a subframe included in the same frame as the SPS resource allocation to be skipped. For example, in an FDD uplink configuration, the DCI subframe associated with the subframe including the SPS resource allocation may be an n minus 4th subframe (e.g., subframe 1 in FIG. 7A), where n is the subframe for the SPS transmission (e.g., subframe 5 in FIG. 7A). In some aspects, the UE 145, 250 may receive and identify the skip indicator in a previous discontinuous reception (DRX) On duration or another awake state, which improves versatility of the skip indicator and/or conserves battery power of the UE 145, 250.

As shown by reference number 710, the UE 145, 250 may skip the communication period associated with the subsequent SPS resource allocation after receiving the skip indicator. For example, the UE 145, 250 may not transmit or receive information regarding a communication associated with the subsequent SPS resource allocation. In some aspects, the eNB 110, 210, 230 may allocate resources of the subsequent SPS resource allocation for other communications (e.g., communications by another UE 145, 250, other communications by the UE 145, 250 that received the skip indicator, and/or the like). In this way, SPS can be employed with regard to the UE 145, 250 while maintaining scheduling flexibility of the cellular network.

As shown by reference number 712, the UE 145, 250 may resume transmission on the SPS resource allocation after the subsequent SPS resource allocation. In this way, resources associated with the SPS resource allocation may be dynamically re-allocated without tearing down or reconfiguring the SPS configuration of the UE 145, 250.

FIG. 7B is an example of reallocating an SPS resource allocation to a different subframe based at least in part on a skip indicator. As shown, an eNB 110, 210, 230 may provide an SPS activation message to a UE 145, 250, as described in connection with FIG. 7A, above. As shown by reference number 714, the UE 145, 250 may receive a skip indicator from the eNB 110, 210, 230. As further shown, the skip indicator may indicate that a subsequent SPS resource allocation is to be reassigned to a different subframe (e.g., subframe 3 of the next frame). For example, the eNB 110, 210, 230 may schedule the communication associated with the subsequent SPS resource allocation for subframe 3 of the next frame instead of subframe 5 of the current frame, and may transmit the skip indicator indicating that the UE 145, 250 is to transmit the communication on subframe 3 of the next frame.

As shown by reference number 716, the UE 145, 250 may transmit the communication in subframe 3 of the next frame, rather than subframe 5 of the current frame. As shown by reference number 718, the UE 145, 250 may resume transmission in the SPS resource allocation. In this way, the eNB 110, 210, 230 can adjust a periodic grant of the UE 145, 250, and can cause the UE 145, 250 to communicate according to the adjusted grant without tearing down or abandoning the periodic grant.

FIG. 7C is an example of skipping multiple SPS resource allocations based at least in part on a received indicator. As shown in FIG. 7C, and by reference number 720, the UE 145, 250 may receive a skip indicator from the eNB 110, 210, 230 (e.g., based at least in part on the eNB 110, 210, 230 changing a resource allocation associated with a periodic grant for the UE 145, 250), which may indicate a number of subsequent SPS resource allocations to be skipped (e.g., two, as shown in FIG. 7C). As shown by reference numbers 722-1 and 722-2, the UE 145, 250 may not perform transmissions during communication periods associated with two subsequent SPS resource allocations after the skip indicator is received. As shown by reference number 724, the UE 145, 250 may resume transmission in the SPS resource allocation after the two subsequent SPS resource allocations are skipped. In this way, the eNB 110, 210, 230 can adjust a periodic grant of the UE 145, 250 to skip multiple resource allocations, and can cause the UE 145, 250 to communicate according to the adjusted grant without tearing down or abandoning the periodic grant. This conserves network resources as compared to transmitting multiple skip indicators (e.g., one for each SPS resource allocation to be skipped).

FIG. 7D is an example of configuring the UE 145, 250 to skip a SPS resource allocation, and to awaken in a particular subframe to receive scheduling information regarding the SPS resource allocation. As shown in FIG. 7D, and by reference number 726, the UE 145, 250 may receive a skip indicator from the eNB 110, 210, 230. The skip indicator may indicate to skip a next SPS resource allocation (e.g., at subframe 5), as described elsewhere herein.

As further shown, the skip indicator may indicate that the UE 145, 250 is to awaken in a particular subframe (e.g., subframe 6) to receive an uplink grant. As shown by reference number 728, the eNB 110, 210, 230 may provide the uplink grant in the particular subframe (e.g., subframe 6, shown as SF 6) to cause the UE 145, 250 to perform a transmission on subframe 2 of a subsequent frame. As shown by reference number 730, the UE 145, 250 may perform the transmission on subframe 2 of the subsequent frame. In some aspects, the transmission may be scheduled and performed on a same subframe as the skipped SPS resource allocation. As shown by reference number 732, the UE 145, 250 may resume transmission on the SPS resource allocation (e.g., on subframe 5 of the next frame) after transmitting on subframe 8 according to the uplink grant. By scheduling the UE 145, 250 to awaken in a particular subframe to receive scheduling information, the eNB 110, 210, 230 further improves versatility of the periodic grant. For example, the eNB 110, 210, 230 may determine, at the particular subframe, whether the grant is to be provided, and may selectively provide the grant or not provide the grant based at least in part on traffic conditions.

FIG. 7E shows an example of effectively reconfiguring a periodic grant from a first periodicity or interval to a second periodicity or interval based at least in part on a skip indicator. As shown by reference number 734, a UE 145, 250 may receive information identifying an SPS resource allocation at a first periodicity or interval of 40 ms (e.g., associated with a VoLTE talk or listen mode). The UE 145, 250 may receive or transmit information based at least in part on the first periodicity or interval, as described in more detail elsewhere herein.

As shown by reference number 736, the UE 145, 250 may receive a skip indicator after a communication period that starts at approximately 45 ms. As further shown, the skip indicator may identify a second periodicity or interval (e.g., a 160 ms periodicity or interval, which may correspond to a VoLTE silent mode). As shown by reference number 738, the UE 145, 250 may skip communication periods associated with SPS resource allocations that at approximately 85 ms, 125 ms, and 165 ms. As shown by reference number 740, the UE 145, 250 may resume transmission on a communication period associated with an SPS resource allocation at approximately 205 ms. After transmitting at approximately 205 ms, the UE 145, 250 may skip communication periods at approximately 245 ms, 285 ms, and 325 ms, and may again transmit at 365 ms (not shown). In this way, the UE 145, 250 achieves the second periodicity or interval without reconfiguration of the SPS resource allocation. This may save time and resources that would otherwise be used to reconfigure the SPS resource allocation at an RRC level of the UE 145, 250.

In some implementations, an eNB 110, 210, 230 may determine that the UE 145, 250 is to switch from the first periodicity or interval to the second periodicity or interval. For example, the UE 145, 250 may transmit a message, such as a MAC layer control element (CE) indicating that the UE is to switch from the first periodicity or the interval to the second periodicity or interval. Additionally, or alternatively, the eNB 110, 210, 230 may determine that the UE 145, 250 is to switch from the first periodicity or interval to the second periodicity or interval based at least in part on data en route to or from the UE 145, 250. For example, the eNB 110, 210, 230 may detect padding data in uplink traffic of the UE 145, 250, and may transmit the skip indicator accordingly. In this way, the eNB 110, 210, 230 may determine that the UE 145, 250 is to switch from the first periodicity or interval to the second periodicity or interval without the UE transmitting a MAC CE, which conserves resources of the UE 145, 250 in relation to generating and transmitting the MAC CE.

In some aspects, the UE 145, 250 may resume the first interval or periodicity based at least in part on transmitting a scheduling request and/or a buffer status report to the eNB 110, 210, 230. For example, the scheduling request and/or the buffer status report may include a zero-byte buffer size, or a buffer size that is smaller than or equal to a payload of the traffic associated with a subsequent SPS resource allocation that was skipped based at least in part on the skip indicator. In this way, the eNB 110, 210, 230 may determine that the UE 145, 250 is to switch back to the first periodicity or interval without the UE transmitting a MAC CE, which conserves resources of the UE 145, 250 in relation to generating and transmitting the MAC CE.

While techniques and apparatuses, described herein, are described primarily in the context of SPS, techniques and apparatuses are not limited to SPS. For example, aspects described herein may be applied for any type of resource grant occurring at a predefined interval. Furthermore, while FIGS. 7A-7E are described in the context of transmissions during SPS resource allocations and/or reconfigured resource allocations, FIGS. 7A-7E are equally applicable to receptions during such resource allocations.

As indicated above, FIGS. 7A-7E are provided as examples. Other examples are possible and may differ from what was described with respect to FIGS. 7A-7E.

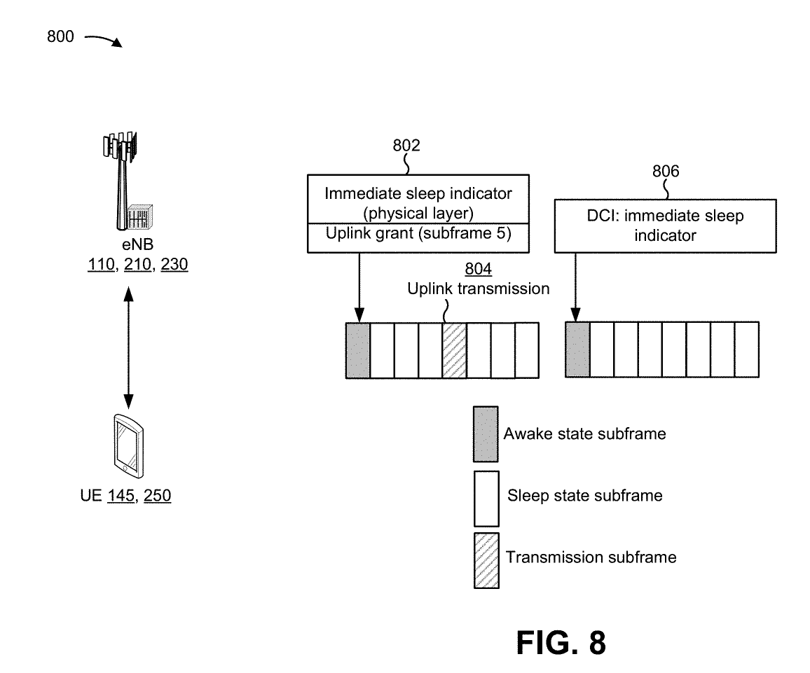

FIG. 8 is a diagram of an example 800 of entering a sleep mode (e.g., an immediate sleep mode) based at least in part on an indicator, in accordance with various aspects of the present disclosure. As shown in FIG. 8, subframes in which the UE 145, 250 is awake are shown using a gray fill, subframes in which the UE 145, 250 is asleep are shown using a white fill, and subframes in which the UE 145, 250 communicates (e.g., transmits) are shown using a diagonal pattern fill.

As shown by reference number 802, the UE 145, 250 may receive, in physical layer information (e.g., the PHY layer), a first sleep indicator (e.g., immediate sleep indicator). In some aspects, the first sleep indicator may cause the UE 145, 250 to enter a sleep mode in a next subframe (e.g., a subframe immediately following a subframe in which the immediate sleep indicator was received). For example, the UE 145, 250 may be in an On duration of a DRX cycle when the first sleep indicator is received, and the sleep indicator may be received in downlink control information of a subframe. By causing the UE 145, 250 to enter the sleep mode of the DRX cycle, resources of the UE 145, 250 may be conserved (e.g., when no transmission or reception other than the scheduled transmission is expected).

As further shown, the downlink control information may include an uplink grant for the transmission to be performed by the UE 145, 250. For example, the immediate sleep indicator may be included in the uplink grant, which conserves network resources relative to transmitting a dedicated packet with the sleep indicator, and which enables transmission of the sleep indicator without transmitting a dedicated packet or communication. In some aspects, the UE 145, 250 may receive stand-alone downlink control information (e.g., a dedicated packet or communication) with the sleep indicator, which permits transmission of the sleep indicator when no uplink grant is to be transmitted. In some aspects, the downlink control information may include a downlink grant for a downlink transmission to be received by the UE 145, 250. As shown by reference number 804, the UE 145, 250 may awaken to transmit a communication associated with the uplink grant.

As shown by reference number 806, the UE 145, 250 may receive a second sleep indicator (e.g., immediate sleep indicator) in downlink communication information. Based at least in part on the second immediate sleep indicator, the UE 145, 250 may enter a sleep mode in a next subframe. As further shown, the UE 145, 250 may enter a sleep state according to the second immediate sleep indicator. In this way, the UE 145, 250 conserves resources of the UE 145, 250 that would otherwise be used to awaken (e.g., based at least in part on a cycle, such as a DRX cycle and/or the like) when no communication is planned or scheduled.

In some aspects, the process described in connection with FIG. 8 may be applied with regard to the operations described in connection with FIGS. 7A-7E, above. For example, the UE 145, 250 may enter the sleep mode based at least in part on an immediate sleep indicator when an SPS resource allocation is not to be used for uplink traffic. In this way, resources of the UE 145, 250 are conserved, and the SPS resource allocation may be used for other traffic, thereby improving flexibility of scheduling of traffic.

As indicated above, FIG. 8 is provided as an example. Other examples are possible and may differ from what was described with respect to FIG. 8.

FIG. 9 is a diagram illustrating an example process 900 performed, for example, by a UE, in accordance with various aspects of the present disclosure. Example process 900 is an example where a UE (e.g., UE 145, 250) performs temporary modification of a periodic grant.

As shown in FIG. 9, in some aspects, process 900 may include receiving an indicator associated with a periodic grant configuration, wherein the indicator identifies a release of a subsequent resource allocation of the UE (block 910). For example, the UE may receive an indicator associated with a periodic grant configuration of resource allocations for the UE. The indicator may identify a release of a subsequent resource allocation of the UE (e.g., subsequent to receipt of the indicator).

As shown in FIG. 9, in some aspects, process 900 may include skipping at least one communication period (e.g., for traffic) associated with the subsequent resource allocation of the UE based at least in part on receiving the indicator (block 920). For example, the UE may skip at least one communication period (e.g., may skip transmission and/or reception during the at least one communication period) based at least in part on receiving the indicator. In some aspects, the UE may skip multiple, different communication periods, as described in more detail elsewhere herein.

As shown in FIG. 9, in some aspects, process 900 may include communicating in a communication period for traffic associated with a resource allocation that follows the subsequent resource allocation of the UE (block 930). For example, the UE may resume communication during a resource allocation that follows the subsequent resource allocation of the UE. In this way, the UE can be configured to skip communication on one or more resource allocations without tearing down or reconfiguring the periodic grant configuration, which improves flexibility of traffic scheduling in the cellular network.

In some aspects, the indicator may be received in a subframe other than a subframe associated with a downlink control channel for the communication period. In some aspects, the indicator may further identify at least one of a particular subframe, resource block, or modulation and coding scheme. A communication (e.g., the traffic associated with the subsequent resource allocation) may be received or transmitted in the at least one of the particular subframe, resource block, or modulation and coding scheme.

In some aspects, the indicator may further indicate a particular subframe in which a resource grant is to be received. The UE may be configured to enter a sleep mode until an occurrence of the particular subframe.

In some aspects, the indicator may indicate to skip a plurality of communication periods associated with the periodic grant configuration. The plurality of communication periods includes the communication period. The UE may skip the plurality of communication periods.

In some aspects, the periodic grant configuration may be associated with a first periodicity, and the indicator may indicate a second periodicity that is different than the first periodicity. The UE may be configured to skip at least one of a plurality of communication periods to achieve the second periodicity. In some aspects, the indicator may be received based at least in part on padding data in uplink traffic of the UE. In some aspects, the indicator may be received based at least in part on a media access control (MAC) control element (CE) transmitted by the UE. In some aspects, the UE may be configured to resume the first periodicity after transmitting at least one of a scheduling request or buffer status report to trigger returning to the first periodicity. In some aspects, the at least one of the scheduling request or buffer status report may identify at least one of a zero-byte buffer size, or a buffer size that is smaller than or equal to a payload of the traffic associated with the subsequent resource allocation.

In some aspects, the indicator may be a first indicator, and the UE may receive a second indicator to initiate a sleep mode in a subsequent (e.g., a next) subframe, wherein the second indicator is received in downlink control information for a frame including the subsequent (e.g., next) subframe. The UE may initiate the sleep mode in the subsequent subframe based at least in part on the second indicator. In some aspects, the downlink control information may identify an uplink or downlink grant of the UE, wherein the UE is configured to transmit or receive data on the uplink grant. In some aspects, the downlink control information may include a stand-alone downlink control information. In some aspects, the sleep mode may be initiated during a discontinuous reception (DRX) On duration of the UE.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a UE, in accordance with various aspects of the present disclosure. Example process 1000 is an example where a UE (e.g., UE 145, 250) performs temporary modification of a periodic grant.

As shown in FIG. 10, in some aspects, process 1000 may include receiving an indicator to initiate a sleep mode in a subsequent (e.g., a next) subframe, wherein the indicator is received in downlink control information for a frame including the subsequent (e.g., the next) subframe (block 1010). For example, the UE may receive an indicator (e.g., an immediate sleep indicator, described in FIG. 8) to initiate a sleep mode in a subsequent (e.g., a next subframe). In some aspects, the indicator may be received in downlink control information for the subsequent (e.g., the next) subframe. In some aspects, the UE may be in a DRX On duration when the indicator is received.

As shown in FIG. 10, in some aspects, process 1000 may include initiating the sleep mode in the next subframe based at least in part on the indicator (block 1020). For example, the UE may initiate the sleep mode (e.g., the sleep mode of the DRX cycle) in the next subframe after the indicator is received based at least in part on the indicator.

In some aspects, the downlink control information may identify an uplink or downlink grant of the UE, and the UE may be configured to transmit or receive data on the uplink or downlink grant. In some aspects, the downlink control information may include a stand-alone indicator to initiate a sleep mode. In some aspects, the sleep mode may be initiated during the DRX On duration of the UE.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

The foregoing disclosure provides illustration and description, but is not intended to be exhaustive or to limit the aspects to the precise form disclosed. Modifications and variations are possible in light of the above disclosure or may be acquired from practice of the aspects.

As used herein, the term component is intended to be broadly construed as hardware, firmware, or a combination of hardware and software. As used herein, a processor is implemented in hardware, firmware, or a combination of hardware and software.

Some aspects are described herein in connection with thresholds. As used herein, satisfying a threshold may refer to a value being greater than the threshold, greater than or equal to the threshold, less than the threshold, less than or equal to the threshold, equal to the threshold, not equal to the threshold, and/or the like.

It will be apparent that systems and/or methods, described herein, may be implemented in different forms of hardware, firmware, or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of possible aspects. In fact, many of these features may be combined in ways not specifically recited in the claims and/or disclosed in the specification. Although each dependent claim listed below may directly depend on only one claim, the disclosure of possible aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the term “one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

1. A method of wireless communication, comprising:
receiving, by a user equipment (UE), an indicator associated with a periodic grant configuration,
wherein the indicator identifies a release of a subsequent resource allocation of the UE; and
skipping, by the UE, at least one communication period associated with the subsequent resource allocation of the UE based at least in part on receiving the indicator.

2. The method of claim 1, further comprising communicating in a communication period associated with a resource allocation that follows the subsequent resource allocation of the UE.

3. The method of claim 1, wherein the indicator is received in a subframe other than a subframe associated with a downlink control channel for the at least one communication period.

4. The method of claim 1, wherein the indicator further identifies at least one of a particular subframe, resource block, or modulation and coding scheme,
wherein a communication is to be received or transmitted in the at least one of the particular subframe, resource block, or modulation and coding scheme.

5. The method of claim 1, wherein the indicator indicates a particular subframe in which a resource grant is to be received; and
wherein the UE is configured to enter a sleep mode until an occurrence of the particular subframe.

6. The method of claim 1, wherein the indicator indicates to skip a plurality of communication periods associated with the periodic grant configuration,
wherein the plurality of communication periods includes the at least one communication period; and
wherein skipping the at least one communication period comprises skipping the plurality of communication periods.

7. The method of claim 1, wherein the periodic grant configuration is associated with a first periodicity;
wherein the indicator indicates a second periodicity that is different than the first periodicity; and
wherein the UE is configured to skip at least one of a plurality of communication periods to achieve the second periodicity.

8. The method of claim 7, wherein the indicator is received based at least in part on padding data in uplink traffic of the UE.

9. The method of claim 7, wherein the indicator is received based at least in part on a media access control (MAC) control element (CE) transmitted by the UE.

10. The method of claim 7, wherein the UE is configured to resume the first periodicity after transmitting at least one of a scheduling request or buffer status report to trigger returning to the first periodicity.

11. The method of claim 10, wherein the at least one of the scheduling request or buffer status report identifies at least one of:
a zero-byte buffer size, or
a buffer size that is smaller than or equal to a payload of traffic associated with the subsequent resource allocation.

12. The method of claim 1, wherein the indicator is a first indicator; and
wherein the method further comprises:
receiving a second indicator to initiate a sleep mode in a next subframe,
wherein the second indicator is received in downlink control information for a subframe; and
initiating the sleep mode in the next subframe based at least in part on the second indicator.

13. The method of claim 12, wherein the downlink control information identifies an uplink or downlink grant of the UE; and
wherein the UE is configured to transmit or receive data on the uplink or downlink grant.

14. The method of claim 12, wherein the downlink control information includes a stand-alone indicator to initiate a sleep mode.

15. The method of claim 12, wherein the sleep mode is initiated during a discontinuous reception (DRX) On duration of the UE.

16. A method of wireless communication, comprising:
receiving, by a user equipment (UE), an indicator to initiate a sleep mode in a subsequent subframe,
wherein the indicator is received in downlink control information for a frame including the subsequent subframe; and
initiating, by the UE, the sleep mode in the subsequent subframe based at least in part on the indicator.

17. The method of claim 16, wherein the downlink control information identifies an uplink or downlink grant of the UE; and
wherein the UE is configured to transmit or receive data on the uplink or downlink grant.

18. The method of claim 16, wherein the downlink control information includes a stand-alone downlink control information.

19. The method of claim 16, wherein the sleep mode is initiated during a discontinuous reception (DRX) On duration of the UE.

20. The method of claim 16, further comprising skipping a communication period associated with a next periodic resource allocation of the UE based at least in part on receiving the indicator.

21. The method of claim 16, wherein the downlink control information includes physical layer information.

22. A user equipment (UE) for wireless communication, comprising:
a memory; and
at least one processor operatively coupled to the memory and configured to:
receive an indicator associated with a periodic grant configuration, wherein the indicator identifies a release of a subsequent resource
allocation of the UE; and
skip at least one communication period associated with the subsequent resource allocation of the UE based at least in part on receiving the indicator.

23. The UE of claim 22, wherein the at least one processor is further configured to communicate in a communication period associated with a resource allocation that follows the subsequent resource allocation of the UE.

24. The UE of claim 22, wherein the indicator is received in a subframe other than a subframe associated with a downlink control channel for the at least one communication period.

25. The UE of claim 22, wherein the indicator indicates a particular subframe in which a resource grant is to be received; and
wherein the UE is configured to enter a sleep mode until an occurrence of the particular subframe.

26. The UE of claim 22, wherein the indicator indicates to skip a plurality of communication periods associated with the periodic grant configuration,
wherein the plurality of communication periods includes the at least one communication period; and
wherein the UE is further configured to skip the plurality of communication periods.

27. The UE of claim 22, wherein the periodic grant configuration is associated with a first periodicity;
wherein the indicator indicates a second periodicity that is different than the first periodicity; and
wherein the UE is configured to skip at least one of a plurality of communication periods to achieve the second periodicity.

28. The UE of claim 27, wherein the indicator is received based at least in part on padding data in uplink traffic of the UE.

29. The UE of claim 27, wherein the UE is configured to resume the first periodicity after transmitting at least one of a scheduling request or buffer status report to trigger returning to the first periodicity.

30. A user equipment (UE) for wireless communication, comprising:
a memory; and
at least one processor operatively coupled to the memory and configured to:
receive an indicator to initiate a sleep mode in a subsequent subframe,
wherein the indicator is received in downlink control information for a frame including the subsequent subframe; and
initiate the sleep mode in the subsequent subframe based at least in part on the indicator.
